(19) United States
(12) Patent Application Publication
(10) Pub. No.: US 2011/0034189 A1
(43) Pub. Date: Feb. 10, 2011

(54) METHODS AND SYSTEMS FOR IDENTIFYING TRANSMITTERS IN A SINGLE FREQUENCY NETWORK BROADCAST SYSTEM

(75) Inventors: Rashmin Anjaria, San Diego, CA (US); Mathew Joseph, San Diego, CA (US)

Correspondence Address: McDermott Will & Emery LLP, 600 13th Street, NW, Washington, DC, 20005-3096, US

(73) Assignee: QUALCOMM Incorporated, San Diego, CA (US)

(21) Appl. No.: 12/536,340

(22) Filed: Aug. 5, 2009

(51) Int. Cl. H04B 17/00; H04B 7/00

(52) U.S. Cl. 455/500; 455/67.11

(57) ABSTRACT

Methods and systems for identifying transmitters within a single frequency network calculates signal path delays to a measurement location from each transmitter based on separation distance and individual transmitter transmission variances. Scenarios of predicted signal arrival times are calculated using the signal path delays, with each scenario assuming a different transmitter source of the strongest received signal within a short channel. Short channels with non-zero power measurements may be clustered into groups corresponding to each transmitter's expected signal arrival short channel. The scenario best matching the data may be determined, such as by adding the power measurements within each cluster of each scenario to determine a total received power associated with each scenario. The scenario most correlated to the power measurements identifies the transmitter associated with the strongest signal transmitters in network. Power measurements within each cluster can then be used to calculate the received signal strength for each transmitter.

### BACKGROUND

The relatively new field of mobile broadcast television services enables broadcasting television and other content to mobile devices, such as cellular telephones. Mobile television (TV) broadcast services allow users to view TV programming, as well as receive mobile editions of news, entertainment, sports, business, and other programming, using their cell phone or other wireless mobile device configured to receive the mobile broadcast transmissions. Typically, mobile TV broadcast services employ a single frequency network (SFN) which includes a plurality of transmitters which all broadcast the exact same signal (frequency and content) at approximately the same time. A single frequency network provides performance advantages for broadcasting digital content since the broadcast coverage area can be expanded by deploying additional transmitters. If signals from different transmitters arrive within a certain time window they combine constructively, else they interfere with each other and the receiver may be unable to correctly decode the transmitted signal depending on the relative strength of the signals received from various transmitter at that location. This issue can be addressed in part by adjusting the transmission lag and transmission power of individual transmitters. However, determining the adjustments that should be made to optimize reception throughout the broadcast area may be difficult because the near simultaneous transmission of identical signals complicates identifying the transmitters generating the received signals in any one location.

### SUMMARY

The various embodiments provide methods and systems for identifying the various transmitters within a single frequency broadcast network. One or more signal measurements (e.g. power) may be recorded at a variety of locations with each measurement being correlated to the location that the measurements were taken. These signal measurements may be referred to hereinafter as signal measurement data, measurement data, or the like. The locations of the measurements and the locations of each transmitter may be used to calculate a separation distance. Signal path delays can be calculated based upon the separation distances and the individual transmitter transmission variances. Scenarios of the predicted signal arrival times in the form of short channels within a sampling window can be generated based upon the calculated signal path delays, with each scenario assuming a different transmitter as the source of the strongest received signal within a short channel. Short channels with non-zero power measurements may be clustered into groups around the predicted signal arrival short channel corresponding to each transmitter. The scenario best matching the signal measurement data may be determined, such as by adding the power measurements within each cluster of each scenario to determine a total received power associated with each scenario. The scenario that has the highest correlation to the signal measurement data can be used to determine the transmitter associated with the strongest signal at the receiver location as well as the other transmitters. Power measurements within each cluster can then be used to calculate the received signal strength for each transmitter.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a component block diagram of a single frequency network communication system.

FIG. 2 is a process flow diagram illustrating an embodiment method for identifying transmitters and determining received signal power for each identified transmitter at the receive location in a single frequency network.

FIG. 3 is an example set of signal measurement data processable according to an embodiment.

FIG. 4 is a graphical plot of the signal measurement data illustrated in FIG. 3.

FIG. 5A is a graphical plot of an example of noisy signal measurement data.

FIG. 5B is a graphical plot of the signal measurement data shown in FIG. 5A after thresholding has been accomplished.

FIG. 6 is an example table of broadcast transmitter locations.

FIG. 7 is an example table of calculated distances between transmitters and the location at which signal measurements were obtained and signal delay estimated based on those distances.

FIG. 8A is an example table illustrating alternative transmit path scenarios useful in an embodiment analysis method.

FIG. 8B is an example table illustrating alternative transmit path scenarios identifying time channels with non-zero signal measurement values.

FIGS. 9A-9C are example tables of the example of signal measurement data illustrated in FIG. 3 highlighting clusters of time short channels associated with transmitters in three different transmit path scenarios.

FIG. 10 is an example data table illustrating linear summations of received power within clusters of short channels identified in various transmit path scenarios.

FIG. 11 is an example data table listing the time short channel clusters associated with various transmitters in a selected scenario.

FIG. 12 is the graphical plot of signal measurement data illustrated in FIG. 4 labeled to identify particular transmitters based on the conclusions in the data table illustrated in FIG. 11.

FIG. 13A is an example data table listing the measure signal power received at a measurement location.

FIG. 13B is an example data table listing the estimated signal power received from each of the network transmitters.

FIG. 14 is a component block diagram of a signal receiver suitable for accomplishing the various embodiments.

FIG. 15 is a component block diagram of a computer suitable for accomplishing the various embodiment methods.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

Single frequency networks transmit identical signals from multiple transmitters across a geographical region. Since the same signal is transmitted from multiple locations, the radio waves arriving at any location in the broadcast coverage area may be from a number of different transmitters, with each signal traveling a different transmission path. When signals arrive at a location within a certain time window the signals combine constructively. However, if the signals from various transmitters arrive outside the time window, the signals interfere with each other. When the received signal is affected by destructive interference, a user's experience may be affected depending upon the relative strengths of the main signals and the interfering signals, such as by temporarily preventing reception of the broadcast signals.

Operators of single frequency broadcast networks can manage the problem of signals arriving at different times by varying (advancing or delaying) the transmit time of the signals broadcast from different transmitters. By introducing brief variations in the transmission time of one or more transmitters, broadcasters can ensure that the signals arriving at particular locations from two or more transmitters arrive within a constructive time window.

One challenge facing operators of single frequency broadcast networks is assessing the performance of the network in various locations so that transmitters can be adjusted to minimize interference. This challenge is due to the difficulty of identifying each transmitter within a received signal at any location. As is well known, network operators may measure the signal strength and components of radio signals in various locations within the broadcast coverage area using mobile receiver equipment. Such receivers may be installed in vehicles, such as trucks, vans or cars which can take measurements at many locations throughout the broadcast coverage area. Sometimes referred to as a “drive test,” such measurements typically involve recording signal data on computer storage medium, such as a computer hard disk or other electronic data storage devices like memory cards, for later analysis by a computer. The analysis of signal measurement data for multifrequency networks (e.g., cellular telephone networks) is simplified by the fact that transmitters broadcast at different frequencies and include identification codes enabling a processing computer to distinguish the various transmitters emitting the recorded signals. However, in single frequency networks, all transmitters may broadcast exactly the same signal, making differentiation based upon frequency or transmitter identifiers rather difficult.

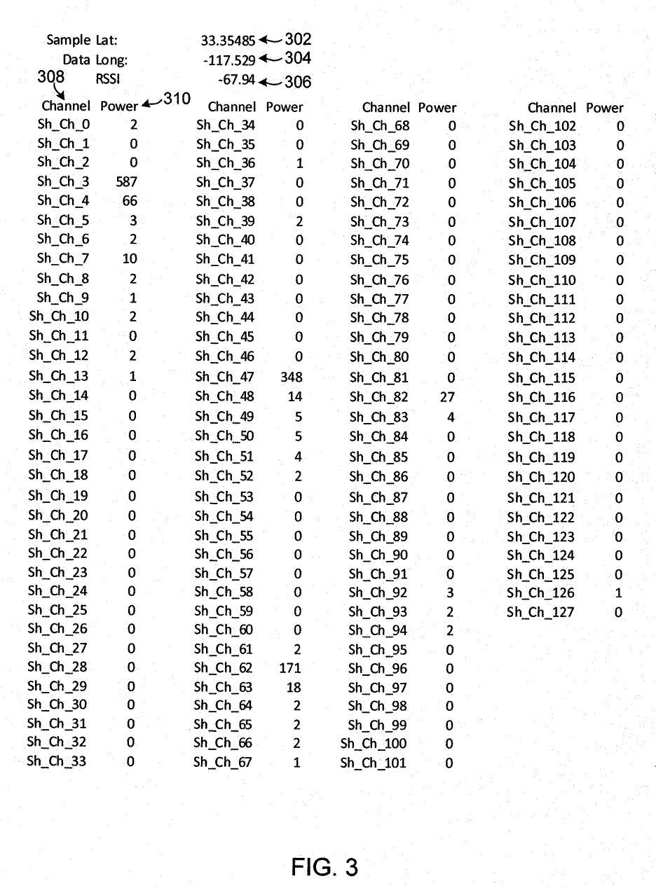

Any of a variety of commercially-available radio frequency signal analyzers/receivers which record received signal strength versus time channels (referred to herein as short channels) may be used for measuring and recording transmitter signals. Such signal analyzers/receivers may record the power of radio signals received within a number of brief time intervals. These brief time intervals, which may be a few microseconds in duration, may be referred to as “short channels” or as “Chip×8” clock units. For example, a commercially available signal analyzer/receiver suitable for use with the various embodiments may be a FLO TV receiver connected to a computer which is configured with appropriate recording software (e.g., QXDM) to record received signal power in 128 short channels each spanning 1.44 microseconds to provide a sampling window of 184.32 microseconds. Such a signal analyzer/receiver may record the power of received signals in each of the 128 time of arrival short channels in a data table (the signal measurement data) similar to the example data illustrated in FIG. 3. Since signal analyzer/receivers are commercially available, the operation of such analyzers is well known and is therefore not described further herein.

The start of a sample window of time short channels recorded by the signal analyzer/receiver is arbitrary. Also, operators cause transmitters to broadcast signals at slightly different times by imposing a time variance on some transmitters. Consequently, the first signal appearing in a signal data sample may not be a signal from the closest transmitter. Further, due to fading and other network and terrain related reasons the closest transmitter may not provide the strongest signal at a particular location. Due to delay spread (typically caused by reflections and scattering), signals from a particular transmitter may not fall within a single short channel. Thus, the source transmitters of the signals recorded by a signal analyzer/receiver can be difficult to determine in a single frequency network.

The various embodiments provide methods and systems for identifying particular transmitters within received signals from a single frequency network. When radio signal measurements are taken by a signal analyzer/receiver, the precise location of the receiver is determined, such as by using a Global Positioning System (GPS) receiver. The recording location is recorded and correlated with signal measurements in the signal measurement data. When the signal measurement data is processed, distances from the receiver location to each of the various network transmitters are calculated using the recorded location of the receiver and the known locations of each transmitter. Based on these calculated distances and the transmission variances assigned to each transmitter, signal path delays are calculated for each transmitter. The signal path delay is the time required for signals from a transmitter to arrive at the receiver location including any transmission time variation imposed on the transmitter. The calculated signal path delays are used to generate a set of scenarios of predicted signal arrival times, with the arrival time expressed in terms of short channels. Different transmitters can be assumed to be the source of the strongest received signal within the sampling time window. The scenarios predict a short channel in which other transmitter signals would be received if a particular transmitter is the source of the strongest signal within the sampling window. Short channels with non-zero power measurements may be clustered into groups corresponding to each transmitter expected reception short channel. Received power measurements within each transmitter cluster of a particular scenario may be added together (i.e. a linear addition) to determine a total received power associated with the scenario, which may serve as a measure of the degree to which the scenario correlates to the signal measurement data. This process is repeated for all of the scenarios with each transmitter assumed to be the one providing the strongest path. The scenario with the best correlation to the signal measurement data, such as the maximum correlated power measurement, is determined. The scenario with the best correlation to the signal measurement data identifies the transmitter providing the strongest signal, as well as all the other transmitters whose signals are received at that location. The short channel clusters of the scenario with a best correlation to the power measurements are used to identify signals arriving from each of the transmitters. Received power measurements within each short channel cluster along with the total received power level may be used to calculate the received signal strength from each of the identified transmitters.

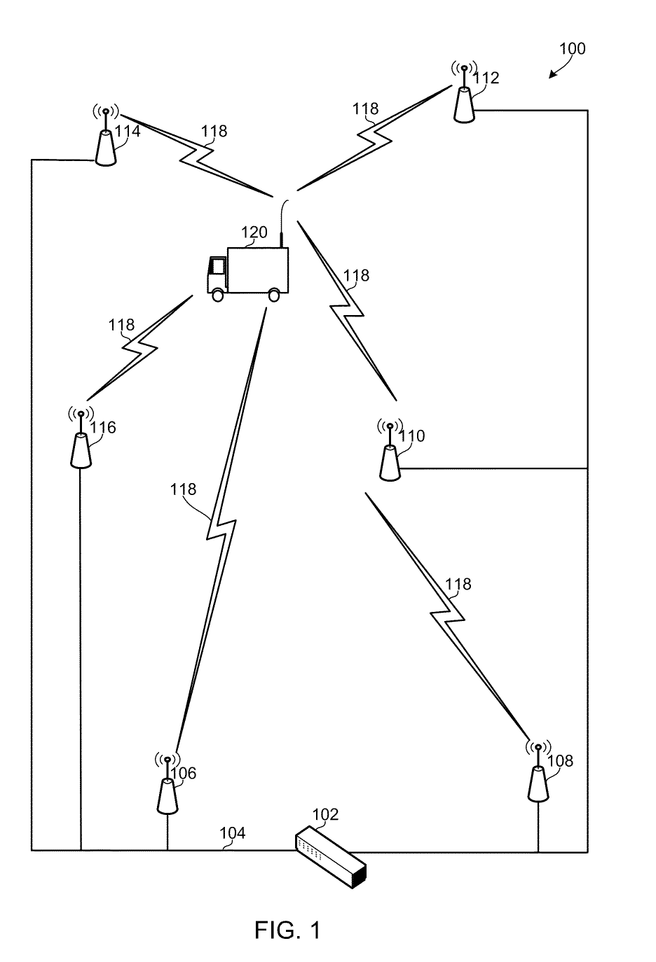

Single frequency network broadcast systems are well known in the art and include mobile TV broadcast systems which are currently being deployed in the United States. A simplified representation of a single frequency network 100 is illustrated in FIG. 1. In a single frequency network 100, a broadcast center 102 provides a common signal via a wired or wireless communication link 104 to each of a plurality of geographically dispersed transmitters 106-116. Each of the transmitters 106-116 broadcasts the same signal 118, although the transmission from each transmitter 106-116 may be varied by an amount programmed into the transmitters by the broadcaster. A signal analyzer/receiver is positioned within the broadcast area, such as by deploying the equipment within a vehicle 120. The signal analyzer/receiver vehicle 120 may be driven to a variety of locations to receive and record broadcast signals 118 throughout the broadcast coverage area. Typically, such signal measurement data is recorded for later processing using embodiment methods and systems.

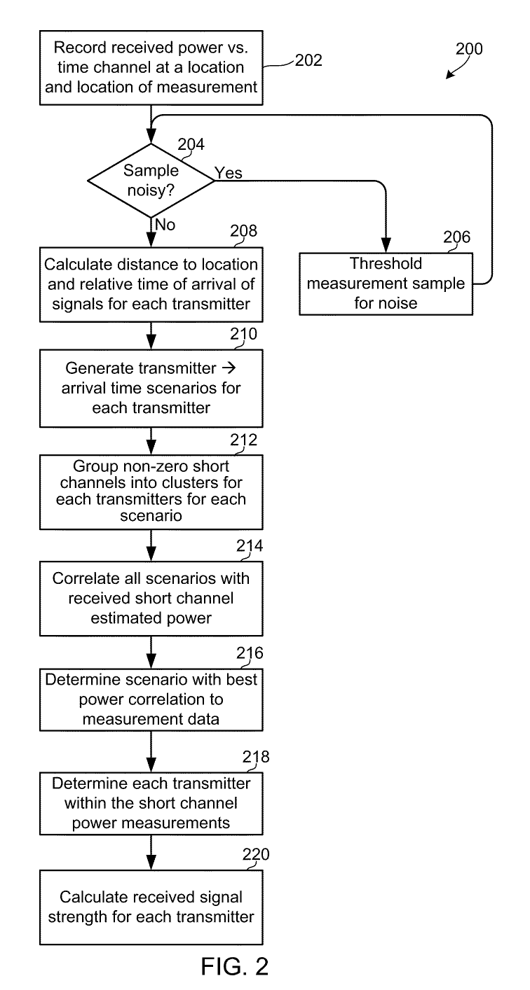

A method 200 for analyzing signal measurement data to identify transmitters and determine the received signal power for each transmitter is illustrated in FIG. 2. Signal measurement data, for example a sample of the signal and a strength of the signal, is recorded by a signal analyzer/receiver at a particular location within a broadcast area, step 202. When a signal measurement is taken, the equipment also records the receiver's location, such as by recording GPS latitude and longitude data from a GPS receiver. As mentioned above, the signal measurement data may be in the form of short channel identifiers correlated to receive signal power within each short channel time window.

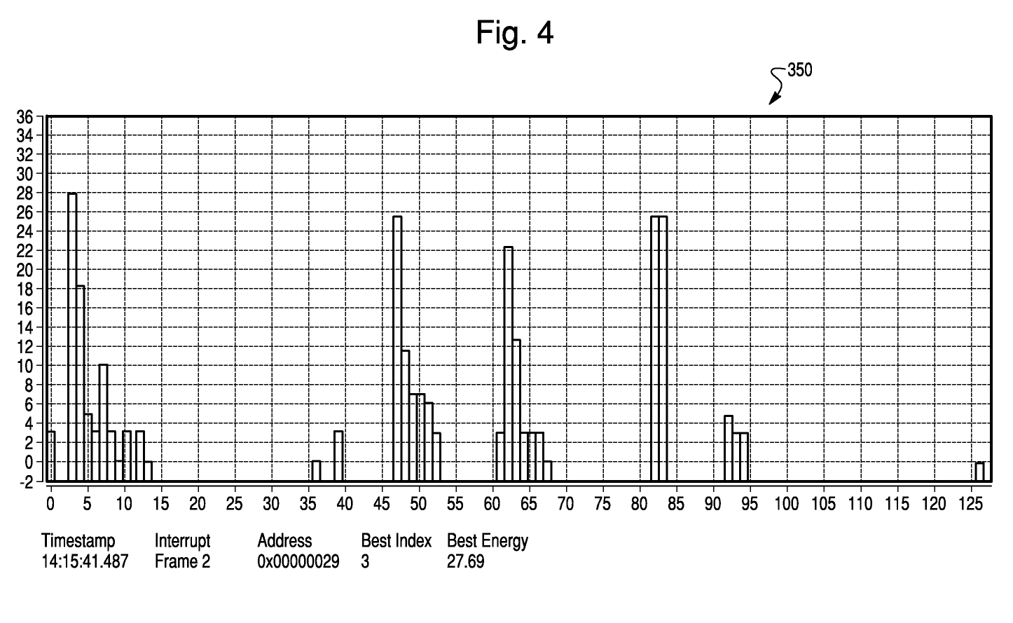

An example of a signal measurement data log recorded by a signal analyzer/receiver is illustrated in FIG. 3. As shown in FIG. 3, the data obtained or recorded in a measurement session may include the measurement location latitude 302, longitude 304, and total received signal strength indication (RSSI) 306. RSSI is a measurement of the power present in a received radio signal and may be expressed in arbitrary units. Measurements of the received signal power within brief intervals called short channels may be recorded in the form of a data pair including a short channel identifier 308 and a power value 310 indicative of the power received in that short channel. The distribution of signal power within a sampling time window may be viewed by plotting power measurements against the short channel numbers as illustrated by chart 350 in FIG. 4. In the example shown in FIG. 4 the short channel with the highest received signal power is short channel 3, which has a received power level of 27.69 (in arbitrary units). While received signals may be distinguished based upon signal strength and time of arrival, the particular identity of individual transmitters is not obvious.

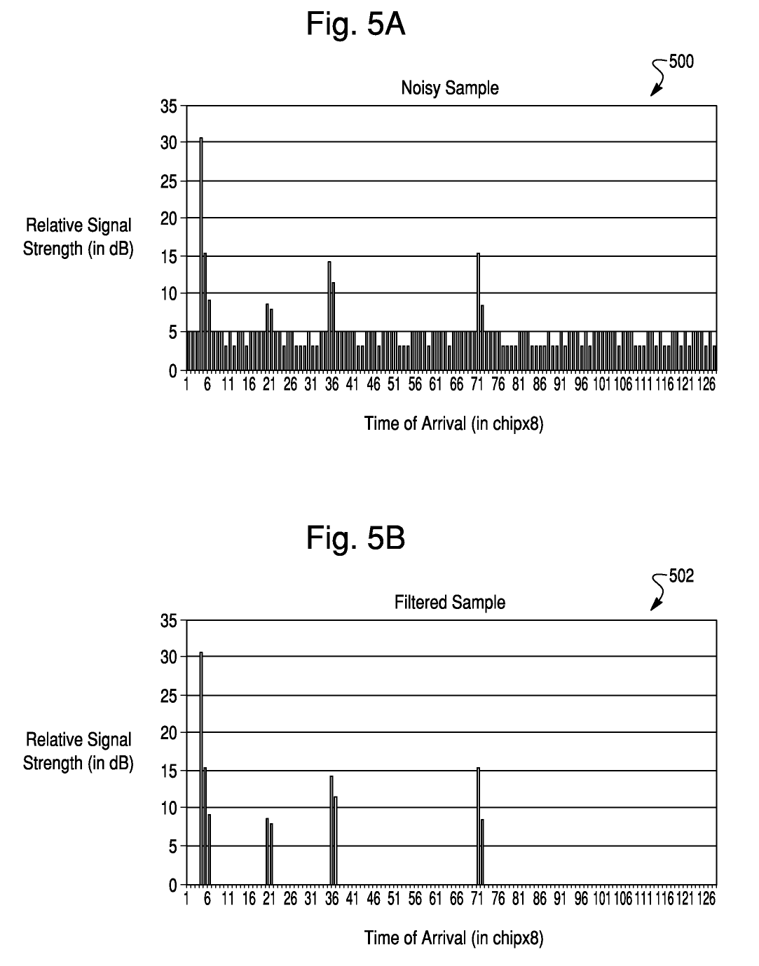

Returning to FIG. 2, when the signal measurement data is analyzed, such as after a number of different measurements have been recorded, a computer analyzing the signal measurement data may determine whether the measurement data is “noisy”, determination 204. FIG. 5A contains a chart 500 that illustrates noisy measurement data in which all or nearly all short channels have non-zero power measurements. Such noise may be caused by electronic noise, background radio noise or interference from other types of radio broadcasts. A variety of mechanisms may be used to determine whether measurement data is noisy, such as by comparing the peak to average power, or counting the number of short channels with non-zero power measurements. If the measurement data is determined to be too noisy for analysis (i.e. determination 204 =“Yes”), the measurement data may be processed to reduce the noise content, step 206. A variety of thresholding mechanisms may be used, such as subtracting an average noise power level from all short channels, setting to zero those short channels whose power level is below a threshold value, or setting to zero those short channels which are less than X dB of a maximum or average received power level. The amount of thresholding may be applied incrementally to reduce the number of short channels with non-zero power measurement values greater than zero to no more than a maximum number. The maximum number of non-zero short channels may be pre-determined or may be dynamically determined (e.g., based on the number of transmitter signals identified in the sample or by determining the average noise floor of the measured data). FIG. 5B contains a chart 502 that provides an illustration of the result of thresholding on the signal measurement data. In particular, the chart 502 shows the signal measurement data after thresholding has been applied to the measurement data illustrated in FIG. 5A.

Thresholding may be performed in an iterative manner, such as performing a first thresholding operation on the measurement data, step 206, and repeating the determination of whether the measurement data is noisy, returning to determination 204. For example, short channels with received power measurements of 1 may be set to zero and the noisy determination repeated to determine whether more than “N” number short channels have non-zero measurement values. The maximum number of “N” short channels may be preset or may be dynamically determined, (e.g., based on the number of transmitter signals identified in the sample or by determining the average noise floor of the measured data) If the measurement data is still too noisy for analysis (i.e., determination 204=“Yes”), a second thresholding operation may set to zero those short channels whose power measurement is 2. Such a process may continue until the measurement data is determined suitable for analysis (i.e., determination 204=“No”), such as when no more than “N” number of short channels have non-zero measurement values.

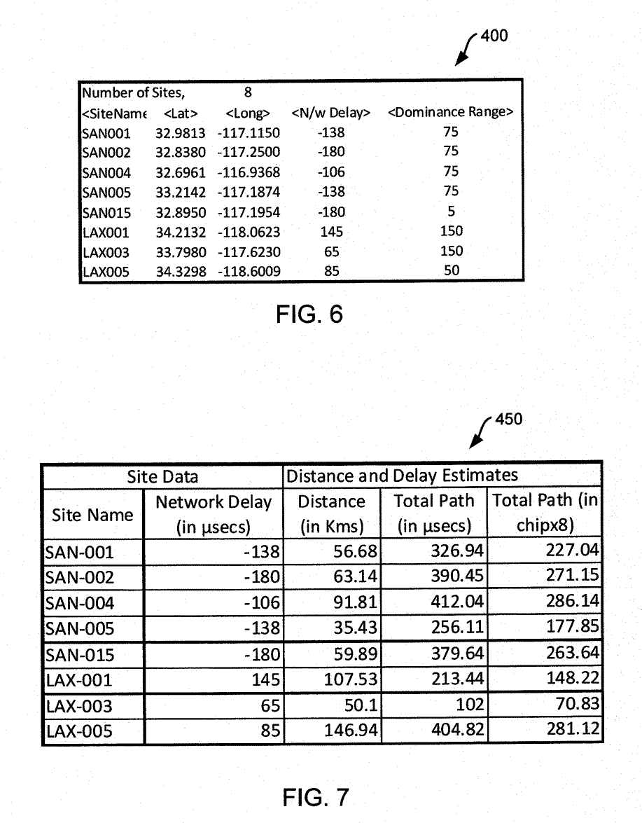

Returning again to FIG. 2, before processing the signal measurement data, the analysis computer may determine the relative time of arrival of signals from each transmitter within the broadcast area, step 208. To accomplish this calculation, the analysis computer may calculate the distance from the receiver location to each of the broadcast transmitters within the broadcast coverage area, determine the time required for radio signals to travel that distance, and add or subtract any variation in signal transmission time for particular transmitters. Data for accomplishing these calculations are provided in the signal measurement data in the form of the measurement location latitude 302 and longitude 304 (see FIG. 3), and the known transmitter location latitude and longitude and signal time variation which may be provided in a data file accessible by the analysis computer. An example of such a transmitter location and configuration data file 400 is shown in FIG. 6. For example, the analysis computer may determine from the transmitter data file 400 shown in FIG. 6 that transmitter SAN-001 is located at latitude 32.9813 and longitude −117.1155 and has a transmission time variation of 138 microseconds. Applying well-known geometric calculations to the latitude and longitude data, the analysis computer can determine the straight line distance between the receiver location and each transmitter. This calculated distance can be divided by the speed of light in air to determine the travel time of signals from each transmitter. Finally, the transmission time variance for each transmitter is added to or subtracted from the calculated travel time to determine the estimated time of arrival of signals in microseconds. This estimated time of arrival then maybe transformed into short channels chip×8. FIG. 7 is an example data table 450 showing the results of this calculation for a particular measurement location. For example, table 450 shows that the analysis computer has calculated that the location of the power measurement associated with the data shown in FIG. 3 was 56.68 km from transmitter SAN-001, so that the total transmission path delay including the network delay of −138 microseconds is estimated to be 326.94 microseconds, which corresponds to 227.04 chip×8.

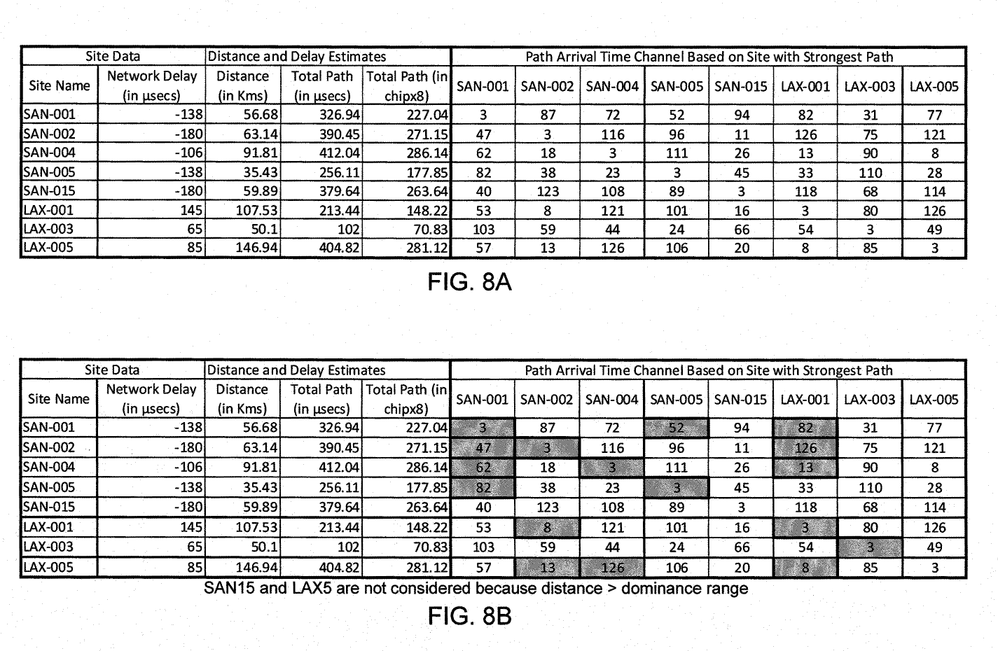

The analysis computer may also determine from the transmitter data file the site dominance region expressed in a radial distance around the transmitter site. The site dominance region is the area within which the transmitter signal can be the dominant signal (or the strongest signal at the receiver location). For example, FIG. 6 shows that transmitter SAN001 has a dominance range of approximately 75 kilometers. It is noted that a transmitter's signal may be received beyond the dominance range. Such dominance range information may be useful for determining whether signals can be expected to be the strongest path received and recorded from a particular transmitter at a given measurement location. Transmitters which are further away from the measurement location then their specified dominance range may be ignored for purposes of the strongest path analysis. This is illustrated, for example, in FIG. 8B where SAN-015 and LAX-005 are not considered because those transmitters are beyond their dominance range at the measurement location.

In a further embodiment, the known antenna propagation pattern may be used as part of the strongest path analysis. As is well known, antenna systems may produce one of almost infinite number of radiation patterns, emitting stronger signals in some directions and weaker signals in others. Antenna propagation patterns are typically measured, and thus such information may be included in a transmitter location and configuration data file available to the analysis computer. Using the geographic positions of each transmitter and the measurement location, the analysis computer can determine the angle of arrival of signals at the measurement location from each transmitter. Some receivers may also measure the angle of arrival of signals. By comparing the determined or measured angle of arrival of signals to the antenna propagation patterns of each transmitter, the analysis computer can further refine the dominance range estimated for each transmitter for the particular measurement point, that is, along the angle of arrival to the location. This refined, location-specific estimation of the dominance range can then be used to eliminate transmitters from the strongest path analysis that are not expected to be the dominant source at the measurement location given their propagation pattern.

Referring once again to FIG. 2, at step 210, using the calculated total path delay values (examples of which are shown in FIG. 7) and the signal measurement data (an example of which is shown in FIG. 3), the analysis computer generates time of arrival scenarios for each of the transmitters. The time of arrival scenarios identify the expected time of arrival short channel for each transmitter at the measurement location assuming one particular transmitter is the source of the short channel with the strongest received signal (e.g., short channel 3 in FIG. 3). An example of such scenarios is illustrated by table 460 in FIG. 8A which lists the various scenarios in the vertical columns on the right-hand side of the data table. For example, the scenario in which transmitter SAN-001 is presumed to be the source of the strongest short channel signal (i.e. short channel 3) predicts that signals from transmitter SAN-002 will arrive in short channel 47, signals from transmitter SAN-004 will arrive in short channel 62, signals from transmitter SAN-005 will arrive in short channel 82, signals from transmitter SAN-015 will arrive in short channel 40, signals from transmitter LAX-001 will arrive in short channel 53, signals from transmitter LAX-003 will arrive in short channel 103, and signals from transmitter LAX-005 will arrive in short channel 57. As FIG. 8A illustrates, each scenario presumes a different transmitter is the source of the strongest signal short channel.

Table 462 in FIG. 8B highlights the short channels with non-zero power measurements within each of the various scenarios. This figure illustrates how correlating measured short channel power levels (non-zero short channels) to the time of arrival for different transmitters for different scenarios may yield inaccurate or inconclusive results. For example, the scenario with the most number of signal arrival short channels with non-zero power measurements is LAX-001, with five non-zero short channels compared to scenario SAN-001 with four non-zero short channels. However, transmitter LAX-001 is over 50 km farther away from the measurement location than transmitter SAN-001, so LAX-001 should not exhibit the strongest received signal. Thus, further analysis of the measurement data is required to accurately identify the strongest transmitter and, from that information, determine the correct scenario for correlating measured power signals to various transmitters.

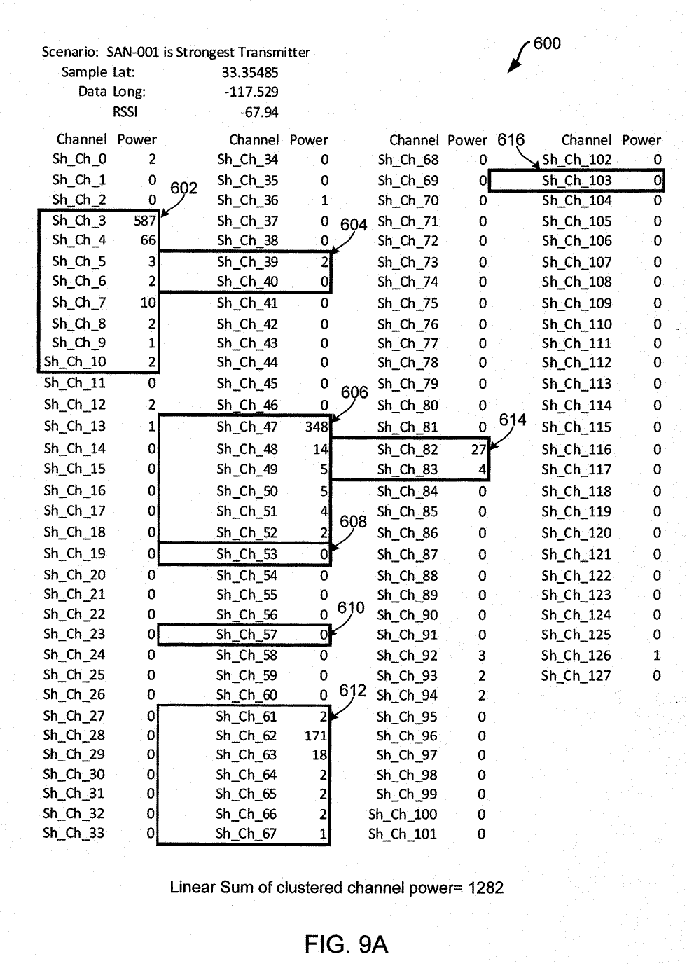

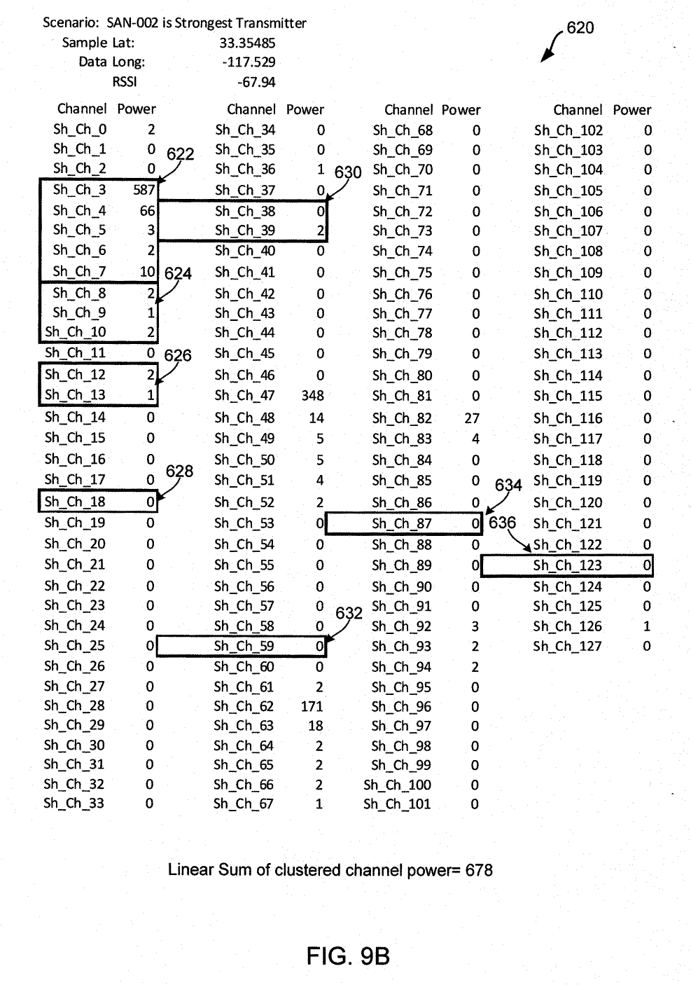

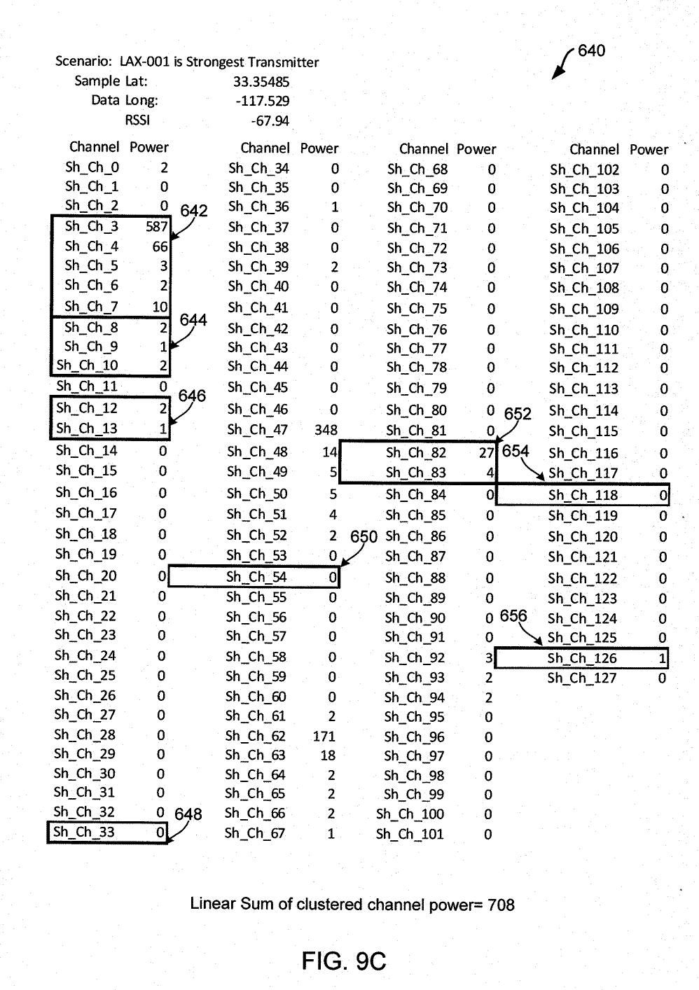

Referring again to FIG. 2, an analysis computer may group non-zero short channels into clusters corresponding to each of the transmitters within each of the various scenarios, step 212. By selecting clusters of short channels, the analysis computer can evaluate the received power within time periods longer than that of each short channel to account for power received from indirect (e.g., multipath) transmission paths which arrive at the measurement location slightly delayed. A variety of methods may be implemented by the analysis computer for identifying clusters of short channels associated with a particular transmitter within particular scenarios. In an example method, the analysis computer selects short channel with non-zero measurement values that fall before and after the scenario short channel in which the signal is projected to arrive, with the selection continuing until either a short channel with a zero value is encountered or another transmitter predicted short channel is encountered. The commencement of the clustering process may impact the power assigned to each cluster. In the example method, clustering starts from the beginning of the time window. Other methods of clustering may also be used. The selected short channels are then identified as a cluster belonging to that particular transmitter. This example method of clustering short channels is illustrated in FIGS. 9A-9C which are described below.

FIG. 9A includes a data set 600 useful for illustrating clustering of short channels that correspond to the scenario where the strongest signal is received from transmitter SAN-001. It can be seen in FIG. 8A that the SAN-001 scenario assumes the strongest signal will be received from the SAN-001 transmitter. Thus, short channel 3 which has the strongest signal in this example data (see FIGS. 3 and 4) is selected as a starting point for forming the cluster belonging to transmitter SAN-001. Implementing the method described above, the analysis computer would consider the preceding short channel, which in this case is short channel 2. Since short channel 2 has a zero power measurement value, short channel 2 would not be included in the cluster. The analysis computer would then consider the subsequent short channel, which in this case is short channel 4. Since short channel 4 has a non-zero measurement value (specifically a value of 66), short channel 4 would be selected for inclusion in the cluster and the analysis computer would consider the next short channel, namely short channel 5. Since short channel 5 has a non-zero power measurement value, the short channel would be selected for inclusion in the cluster and the analysis computer which considered the next short channel. This process continues until a short channel with a zero power measurement value is encountered, which in this example would be short channel 11. The selected short channels, namely short channels 3-10, would then be considered a cluster 602 belonging to transmitter SAN-001.

The analysis computer would repeat this process for the next predicted transmitter signal arrival short channel. In the example SAN-001 scenario listed in FIG. 8A the next predicted signal arrival short channel is 40 which is the predicted signal arrival short channel for signals broadcast by transmitter SAN-015. Referring to FIG. 9A, the analysis computer would consider the preceding short channel, which in this case is short channel 39. Since short channel 39 is a non-zero measurement value in this example data (i.e., 2), short channel 39 would be selected for inclusion in the SAN-015 cluster. The analysis computer would then consider the subsequent short channel, which in this case is short channel 41. Since short channel 41 has a zero power measurement value, that short channel would not be selected and the process of selecting short channels would end. The selected short channels, namely short channels 39 and 40, would then be considered a cluster 604 belonging to transmitter SAN-015.

By repeating this process for each of the predicted arrival short channels in scenario SAN-001, an analysis computer would cluster short channels as illustrated in FIG. 9A, generating clusters 602 through 616.

The process of clustering short channels is repeated for each of the different scenarios. For example, as illustrated by data set 620 in FIG. 9B, to cluster short channels for scenario SAN-002 (i.e., the scenario in which transmitter SAN-002 is presumed to have the strongest received power) the analysis computer would begin with short channel 3 and select adjacent short channels until either a zero power measurement value is encountered or another predicted transmitter signal arrival short channel is encountered. In the case of scenario SAN-002 in the example data set, if short channel 3 includes power from transmitter SAN-002 the scenario predicts that signals from transmitter LAX-001 would be received in short channel 8. Thus, in selecting short channels for clusters belonging to transmitter SAN-002, the analysis computer will stop selecting short channels at short channel 8, concluding that short channels 3-7 should be allocated to a cluster 622 belonging to SAN-002. The analysis computer would then begin selecting short channels for a cluster 624 belonging to transmitter LAX-001. Since short channel 11 has a zero power measurement value, the analysis computer would conclude that the cluster 624 belonging to transmitter LAX-001 includes short channels 8, 9 and 10, as illustrated. By repeating this process for each of the predicted arrival short channels in scenario SAN-002, an analysis computer would cluster short channels as illustrated in FIG. 9B, generating clusters 622 through 636.

FIG. 9C includes a data set 640 providing a further illustration of the application of this clustering method to scenario LAX-001 using the example the signal measurement data illustrated in FIG. 3. In particular, clusters 642 through 656 are illustrated. As mentioned above with reference to FIG. 8B, more of the predicted arrival short channels in scenario LAX-001 have non-zero power measurement values than in scenario SAN-001. However, when the short channels are clustered around predicted arrival short channels in the LAX-001 scenario the clustering excludes many short channels with non-zero power measurement values. For example, short channels 47 through 52 and 61 through 67 are not included in clusters in the LAX-001 scenario. Thus, even though the LAX-001 scenario has a better match in terms of non-zero power measurement for the predicted arrival short channels, a comparison of FIG. 9A to FIG. 9C reveals that the SAN-001 scenario may be a better fit to the measurement data when slightly delayed (e.g. multipath) signals are included in the analysis.

Referring again to FIG. 2, the analysis computer may compute a correlation of each of the scenarios with the total received channel estimated power, step 214. As mentioned above, one method for calculating a correlation of each scenario to the signal measurement data considers whether the predicted arrival short channels of the scenario have non-zero measurement values. However, as described above, this correlation may not be accurate in all situations, as can be seen by comparing the clustering results distributed in FIG. 9B to those in FIG. 9C.

Another method for measuring the correlation of each scenario to the signal measurement data involves calculating the linear sum of the received short channel signal measurement data within all of the clustered short channels to arrive at a total estimation of received power for each scenario. This total of power measurements within all clusters provides a single figure of merit for how well the scenario short channel clusters match the signal measurement data. For example, referring to FIG. 9A, summing the power measurement values within each of the clusters 602-616 results in a linear sum value of 1282. Similarly, the sum of the power measurement values within each of the clusters 622-636 illustrated in FIG. 9B results in a value of 678, and the sum of the power measurement values within each of the clusters 642-656 illustrated in FIG. 9C is 708.

Other methods may be used for calculating correlation factors for the various scenarios. For example, a correlation factor may be calculated by applying a weighted sum (instead of a linear sum) to the signal measurement data within clusters, such as by multiplying the measurement values by weighting factors before summing the values, with short channels closer to the predicted arrival short channel having larger weighting factors than short channels removed from the predicted arrival short channel. In a further example method, linear sums of perceived power within the predicted arrival short channel and each of the preceding and succeeding short channels may be calculated, thus bypassing the clustering process described above with reference to FIG. 9A-9C.

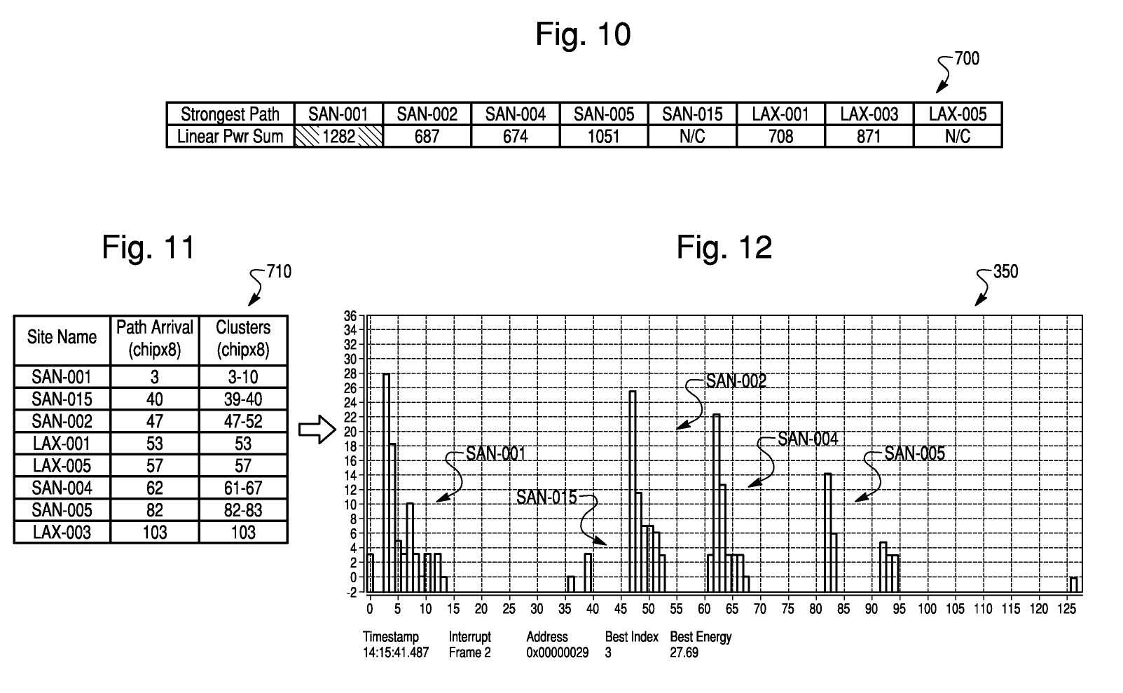

The calculation of a correlation factor is accomplished for each of the scenarios being evaluated by the analysis computer. As mentioned above, the analysis may ignore some of the transmitters as being unlikely sources of the strongest received signals, such as transmitters beyond their dominance range. Using the method of calculating linear sums of power measurement values within clusters with the example measurement data listed in FIG. 3 will yield the totals listed in table 700 illustrated in FIG. 10. In this example, the scenarios associated with transmitters SAN-015 and LAX-005 are not considered because the measurement location is beyond their estimated dominance range, so it is unlikely that signals from these transmitters would be the strongest (i.e., dominant) measured signals at this location which is beyond the specified dominance range of these transmitters.

Referring again to FIG. 2, once the correlation factors have been calculated for each of the scenarios being evaluated the analysis computer may determine the scenario which has the best correlation to the recorded signal measurement data, step 216. Referring to FIG. 10, it can be seen that for the example measurement data shown in FIG. 3, the scenario with the greatest correlation factor based on a linear sum of power measurement values within clusters is scenario SAN-001 with a sum of 1282.

Referring again to FIG. 2, the scenario determined to best correlate with the signal measurement data can then be used to determine the transmitter associated with each cluster of short channel power measurements, step 218. For example, since scenario SAN-001 (i.e., the predicted arrival short channels assuming the strongest signal is received from transmitter SAN-001) was determined to best correlate to the signal measurement data listed in FIG. 3, the signal arrival short channels of that scenario can be used to identify the source transmitters within the signal measurement data as shown in table 710 illustrated in FIG. 11. Non-zero power value short channels nearby a transmitter predicted arrival short channel may be allocated to that transmitter to estimate the total power received from each transmitter. Using the clustering method embodiment described above, an analysis computer may efficiently allocate short channels to clusters associated to each transmitter as illustrated in table 710, FIG. 11. Other methods for assigning short channels to particular transmitters may also be used.

The allocation of short channels to particular transmitters is illustrated in the graph 350 of power level versus short channels illustrated in FIG. 12. This figure illustrates how the foregoing analysis process has identified particular transmitter sources of the received power measurements.

The forgoing analysis method should unambiguously identify transmitters within signal measurement data in most situations. If two paths arrive at the same time and are determined to be the strongest path or if two scenarios yield identical correlations the method may not accurately distinguish the two transmitters. In such a situation, the method may select as the scenario corresponding to the geographically closest transmitter for use in completing the analysis. Thus, in the event of a tie, geographical proximity may be used as the tiebreaker.

Referring again to FIG. 2, having determined the transmitter sources for the received signal measurement data, the analysis computer can calculate the received signal strength from each transmitter, step 220. This calculation may use three sources of information; (a) the sum of all of the individual short channel estimates from the signal measurement data, (b) the total RSSI for the measurement location in dBm, and (c) the linear sum RSSI for the measurement location. For example, the signal measurement data illustrated in FIG. 3 includes a reported RSSI value (RSSI_Value) of −67.94 dBm, and the sum of all 128 short channel power measurements (Total_RSSI_Sum) totals to 1296. Using this input data and the signal measurement data in the clusters of short channels (TransmitterₓCluster-sum of all of the individual short channel estimates from the power measurement associated with a transmitter) associated with the best correlated scenario, the analysis computer can estimate the received signal strength from each transmitter (TSSₓ) in dBm using the following formula which is referred to as Equation 1:

TSSₓ=10 log(TransmitterₓCluster*Linear_RSSI_Value/Total_RSSI_Sum)+30;

where Linear_RSSI_Value=10̂((RSSI_Value−30)/10)

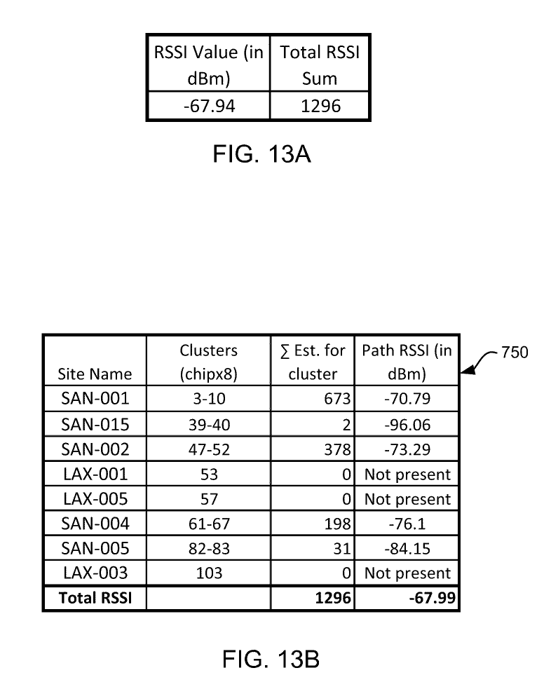

Applying Equation 1 to the signal measurement data illustrated in FIG. 3 results in the transmitter cluster sums and calculated transmitter signal strengths listed in table 750 shown in FIG. 13B. It is noted that the analysis method may determine that no signal strength is detected for some transmitters. It is also noted that the total calculated signal strength in dBm of −67.99 shown in table 750 compares favorably to the measured total signal strength RSSI of −67.94 dBm for the measurement data shown in table 740 in FIG. 13A.

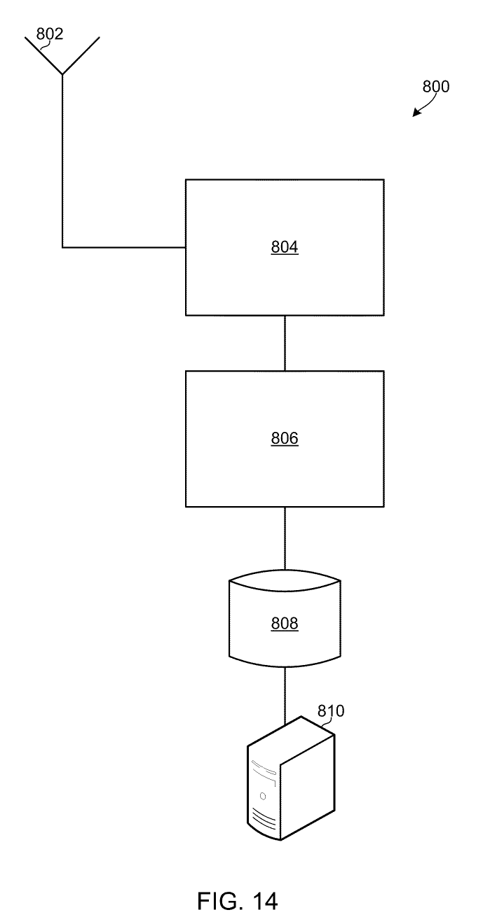

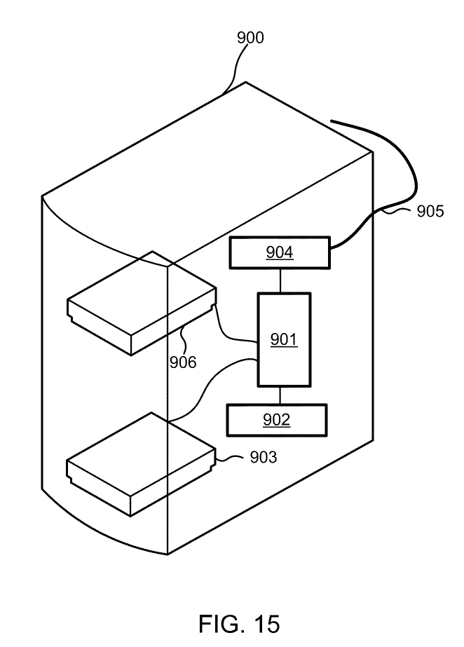

As mentioned above, signal measurement data may be obtained using any of a variety of commercially available signal analyzers/receivers. An example system for receiving, recording and analyzing broadcast signals according to the various embodiments is illustrated in FIG. 14. A signal analyzer/receiver system 800 will typically include an antenna 802 for receiving signals that is coupled to a receiver 804 which can receive and amplify signals of particular frequencies. The receiver 804 may provide the signal of selected frequencies to a signal analyzer 806 which is configured to measure the signal strength within short time samples, referred to herein as short channels. The signal analyzer 806 may store its measurement data in a computer readable format, such as a hard disk drive 808 or other electronic storage data medium described earlier. Information stored on the hard disk drive 808 may then be accessed by an analysis computer 810 which can analyze the data using the various embodiment methods.

The analysis computer 810 may be implemented utilizing any of a variety of general purpose computers, such as the computer 900 illustrated in FIG. 15. Such a computer 900 typically includes a processor 901 coupled to volatile memory 902 and a large capacity nonvolatile memory, such as a disk drive 903. The computer 900 may also include a floppy disc drive and/or a compact disc (CD) drive 906 or other electronic data readers / writers (e.g., memory card readers) coupled to the processor 901. The computer 900 may also include network access ports 904 coupled to the processor 901 for communicating with a network 905, such as to access signal measurement data on disk drive 808(such as illustrated in FIG. 14). The computer 900 may further include user input devices, such as a keyboard and mouse (not shown), and output devices, such as a printer and/or display (not shown).

The processors 901 in the computer 900 may be any programmable microprocessor, microcomputer or multiple processor chip or chips that can be configured by software instructions (applications) to perform a variety of functions, including the functions of the various embodiments described herein. Typically, software applications may be stored in the internal memory (e.g. volatile memory 902 or disc drive 903) before they are accessed and loaded into the processor 901.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored on or transmitted over as one or more instructions or code on a computer-readable medium. The steps of a method or algorithm disclosed herein may be embodied in a processor-executable software module executed which may reside on a computer-readable medium. Computer-readable media includes both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a machine readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method for analyzing signal measurements within a single frequency network, comprising:
calculating a distance from a measurement location to each of a plurality of transmitters within the single frequency network;
generating a plurality of scenarios of predicted signal arrival times for signals from the plurality of transmitters, wherein each of the plurality of scenarios of predicted signal arrival times presumes a different one of the plurality of transmitters is a source of a strongest received signal;
determining which one of the plurality of scenarios best correlates to signal measurement data obtained at the measurement location; and
correlating the signal measurement data to individual transmitters within the plurality of transmitters using the one of the plurality of scenarios determined best correlates to the signal measurement data.

2. The method of claim 1, wherein:
the signal measurement data records received signal power measurements in brief time intervals referred to as short channels within a time window; and
determining which one of the plurality of scenarios best correlates to signal measurement data obtained at the measurement location comprises:
grouping short channels with non-zero power measurements into clusters corresponding to predicted signal arrival times for particular ones of the plurality of transmitters for each of the plurality of scenarios;
calculating a sum of all power measurements within all clusters for each of the plurality of scenarios; and
determining the scenario with the greatest calculated sum of all power measurements within all clusters.

3. The method of claim 1, further comprising calculating a received signal strength for each of the plurality of transmitters.

4. The method of claim 1, further comprising:
determining whether the signal measurement data is noisy; and
thresholding the signal measurement data when the signal measurement data is determined to be noisy.

5. The method of claim 2, further comprising summing power measurements in each short channel within each cluster of the scenarios determined to have the greatest calculated sum of all power measurements within all clusters to determine a received signal strength for each of the plurality of transmitters.

6. The method of claim 5, further comprising calculating a signal strength for each of the plurality of transmitters as follows:
TSSₓ=10 log(TransmitterₓCluster*Linear_RSSI_Value/Total_RSSI_Sum)+30
wherein:
TSSₓ is the transmitter signal strength of a transmitter X in dBm;
TransmitterₓCluster is the sum of signal measurement data in a cluster of short channels corresponding to transmitter X;
RSSI_Value is a total received signal strength indicator (RSSI) of the signal measurement data in dBm;
Total_RSSI_Sum is a sum of all the received short channel signal measurement data; and
Linear_RSSI_Value=10̂((RSSI_Value−30)/10).

7. The method of claim 2, further comprising selecting one of the plurality of scenarios corresponding to a geographically closest transmitter when more than one of the plurality of scenarios has a sum of all power measurements within all clusters equaling the greatest calculated sum of all power measurements within all clusters.

8. The method of claim 1, further comprising ignoring any scenario of predicted signal arrival times for which the calculated distance to the presumed transmitter source of a strongest received signal exceeds a predicted dominance range.

9. The method of claim 9, further comprising:
determining an angle of arrival of signals from at least one of the plurality of transmitters; and
determining a predicted dominance range for at least one of the plurality of transmitters by comparing the determined angle of arrival of signals from the at least one of the plurality of transmitters to an antennal propagation pattern of the at least one of the plurality of transmitters.

10. A computer, comprising:
a processor; and
a memory coupled to the processor,
wherein the processor is configured with processor-executable instructions to perform steps comprising:
receiving a signal measurement data file including signal measurement data obtained at a measurement location within a single frequency network;
calculating a distance from the measurement location to each of a plurality of transmitters within the single frequency network;
generating a plurality of scenarios of predicted signal arrival times for signals from the plurality of transmitters, wherein each of the plurality of scenarios of predicted signal arrival times presumes a different one of the plurality of transmitters is a source of a strongest received signal;
determining which one of the plurality of scenarios best correlates to the signal measurement data; and
correlating the signal measurement data to individual transmitters within the plurality of transmitters using the one of the plurality of scenarios determined best correlates to the signal measurement data.

11. The computer of claim 10, wherein:
the signal measurement data records received signal power measurements in brief time intervals referred to as short channels within a time window; and
the processor is further configured with processor-executable instructions such that determining which one of the plurality of scenarios best correlates to signal measurement data obtained at the measurement location comprises:
grouping short channels with non-zero power measurements into clusters corresponding to predicted signal arrival times for particular ones of the plurality of transmitters for each of the plurality of scenarios;
calculating a sum of all power measurements within all clusters for each of the plurality of scenarios; and
determining the scenario with the greatest calculated sum of all power measurements within all clusters.

12. The computer of claim 10, wherein the processor is configured with processor-executable instructions to perform steps further comprising calculating a received signal strength for each of the plurality of transmitters.

13. The computer of claim 10, wherein the processor is configured with processor-executable instructions to perform steps further comprising:
determining whether the signal measurement data is noisy; and
thresholding the signal measurement data when the signal measurement data is determined to be noisy.

14. The computer of claim 11, wherein the processor is configured with processor-executable instructions to perform steps further comprising summing power measurements in each short channel within each cluster of the scenarios determined to have the greatest calculated sum of all power measurements within all clusters to determine a received signal strength for each of the plurality of transmitters.

15. The computer of claim 14, wherein the processor is configured with processor-executable instructions to perform steps further comprising calculating a signal strength for each of the plurality of transmitters as follows:
TSSₓ=10 log(TransmitterₓCluster*Linear_RSSI_Value/Total_RSSI_Sum)+30
wherein:
TSSₓ is the transmitter signal strength of a transmitter X in dBm;
TransmitterₓCluster is the sum of signal measurement data in a cluster of short channels corresponding to transmitter X;
RSSI_Value is a total received signal strength indicator (RSSI) of the signal measurement data;
Total_RSSI_Sum is a sum of all the received short channel signal measurement data; and
Linear_RSSI_Value=10̂((RSSI_Value−30)/10).

16. The computer of claim 11, wherein the processor is configured with processor-executable instructions to perform steps further comprising selecting one of the plurality of scenarios corresponding to a geographically closest transmitter when more than one of the plurality of scenarios has a sum of all power measurements within all clusters equaling the greatest calculated sum of all power measurements within all clusters.

17. The computer of claim 10, wherein the processor is configured with processor-executable instructions to perform steps further comprising ignoring any scenario of predicted signal arrival times for which the calculated distance to the presumed transmitter source of a strongest received signal exceeds a predicted dominance range.

18. The computer of claim 17, wherein the processor is configured with processor-executable instructions to perform steps further comprising:
determining an angle of arrival of signals from at least one of the plurality of transmitters; and
determining a predicted dominance range for at least one of the plurality of transmitters by comparing the determined angle of arrival of signals from the at least one of the plurality of transmitters to an antennal propagation pattern of the at least one of the plurality of transmitters.

19. A computer, comprising:
means for receiving a signal measurement data file including signal measurement data obtained at a measurement location within a single frequency network;
means for calculating a distance from the measurement location to each of a plurality of transmitters within the single frequency network;
means for generating a plurality of scenarios of predicted signal arrival times for signals from the plurality of transmitters, wherein each of the plurality of scenarios of predicted signal arrival times presumes a different one of the plurality of transmitters is a source of a strongest received signal;
means for determining which one of the plurality of scenarios best correlates to the signal measurement data; and
means for correlating the signal measurement data to individual transmitters within the plurality of transmitters using the one of the plurality of scenarios determined best correlates to the signal measurement data.

20. The computer of claim 19, wherein:
the signal measurement data records received signal power measurements in brief time intervals referred to as short channels within a time window; and
means for determining which one of the plurality of scenarios best correlates to signal measurement data obtained at the measurement location comprises:
means for grouping short channels with non-zero power measurements into clusters corresponding to predicted signal arrival times for particular ones of the plurality of transmitters for each of the plurality of scenarios;
means for calculating a sum of all power measurements within all clusters for each of the plurality of scenarios; and
means for determining the scenario with the greatest calculated sum of all power measurements within all clusters.

21. The computer of claim 19, further comprising means for calculating a received signal strength for each of the plurality of transmitters.

22. The computer of claim 19, further comprising:
means for determining whether the signal measurement data is noisy; and
means for thresholding the signal measurement data when the signal measurement data is determined to be noisy.

23. The computer of claim 20, further comprising means for summing power measurements in each short channel within each cluster of the scenarios determined to have the greatest calculated sum of all power measurements within all clusters to determine a received signal strength for each of the plurality of transmitters.

24. The computer of claim 23, further comprising means for calculating a signal strength for each of the plurality of transmitters as follows:
TSSₓ=10 log(TransmitterₓCluster*Linear_{—}RSSI_Value/Total_{—}RSSI_Sum)+30
wherein:
TSSₓ is the transmitter signal strength of a transmitter X in dBm;
TransmitterₓCluster is the sum of signal measurement data in a cluster of short channels corresponding to transmitter X;
RSSI_Value is a total received signal strength indicator (RSSI) of the signal measurement data;
Total_RSSI_Sum is a sum of all the received short channel signal measurement data; and
Linear_RSSI_Value=10̂((RSSI_Value−30)/10).

25. The computer of claim 20, further comprising means for selecting one of the plurality of scenarios corresponding to a geographically closest transmitter when more than one of the plurality of scenarios has a sum of all power measurements within all clusters equaling the greatest calculated sum of all power measurements within all clusters.

26. The computer of claim 19, further comprising means for ignoring any scenario of predicted signal arrival times for which the calculated distance to the presumed transmitter source of a strongest received signal exceeds a predicted dominance range.

27. The computer of claim 26, further comprising:
means for determining an angle of arrival of signals from at least one of the plurality of transmitters; and
means for determining a predicted dominance range for at least one of the plurality of transmitters by comparing the determined angle of arrival of signals from the at least one of the plurality of transmitters to an antennal propagation pattern of the at least one of the plurality of transmitters.

28. A computer program product, comprising:
a computer readable storage medium comprising:
at least one instruction for receiving a signal measurement data file including signal measurement data obtained at a measurement location within a single frequency network;
at least one instruction for calculating a distance from the measurement location to each of a plurality of transmitters within the single frequency network;
at least one instruction for generating a plurality of scenarios of predicted signal arrival times for signals from the plurality of transmitters, wherein each of the plurality of scenarios of predicted signal arrival times presumes a different one of the plurality of transmitters is a source of a strongest received signal;
at least one instruction for determining which one of the plurality of scenarios best correlates to the signal measurement data; and
at least one instruction for correlating the signal measurement data to individual transmitters within the plurality of transmitters using the one of the plurality of scenarios determined best correlates to the signal measurement data.

29. The computer program product of claim 28, wherein:
the signal measurement data records received signal power measurements in brief time intervals referred to as short channels within a time window; and
the at least one instruction for determining which one of the plurality of scenarios best correlates to signal measurement data obtained at the measurement location stored on the computer readable storage medium comprises:
at least one instruction for grouping short channels with non-zero power measurements into clusters corresponding to predicted signal arrival times for particular ones of the plurality of transmitters for each of the plurality of scenarios;
at least one instruction for calculating a sum of all power measurements within all clusters for each of the plurality of scenarios; and
at least one instruction for determining the scenario with the greatest calculated sum of all power measurements within all clusters.

30. The computer program product of claim 28, wherein the computer readable storage medium further comprises at least one instruction for calculating a received signal strength for each of the plurality of transmitters.

31. The computer program product of claim 28, wherein the computer readable storage medium further comprises:
at least one instruction for determining whether the signal measurement data is noisy; and
at least one instruction for thresholding the signal measurement data when the signal measurement data is determined to be noisy.

32. The computer program product of claim 29, wherein the computer readable storage medium further comprises at least one instruction for summing power measurements in each short channel within each cluster of the scenarios determined to have the greatest calculated sum of all power measurements within all clusters to determine a received signal strength for each of the plurality of transmitters.

33. The computer program product of claim 32, wherein the computer readable storage medium further comprises at least one instruction for calculating a signal strength for each of the plurality of transmitters as follows:
TSSₓ=10 log(TransmitterₓCluster*Linear_{—}RSSI_Value/Total_{—}RSSI_Sum)+30
wherein:
TSSₓ is the transmitter signal strength of a transmitter X in dBm;
TransmitterₓCluster is the sum of signal measurement data in a cluster of short channels corresponding to transmitter X;
RSSI_Value is a total received signal strength indicator (RSSI) of the signal measurement data;
Total_RSSI_Sum is a sum of all the received short channel signal measurement data; and
Linear_RSSI_Value=10̂((RSSI_Value−30)/10).

34. The computer program product of claim 29, wherein the computer readable storage medium further comprises at least one instruction for selecting one of the plurality of scenarios corresponding to a geographically closest transmitter when more than one of the plurality of scenarios has a sum of all power measurements within all clusters equaling the greatest calculated sum of all power measurements within all clusters.

35. The computer program product of claim 29, wherein the computer readable storage medium further comprises at least one instruction for ignoring any scenario of predicted signal arrival times for which the calculated distance to the presumed transmitter source of a strongest received signal exceeds a predicted dominance range.

36. The computer program product of claim 35, wherein the computer readable storage medium further comprises:
at least one instruction for determining an angle of arrival of signals from at least one of the plurality of transmitters; and
at least one instruction for determining a predicted dominance range for at least one of the plurality of transmitters by comparing the determined angle of arrival of signals from the at least one of the plurality of transmitters to an antennal propagation pattern of the at least one of the plurality of transmitters.
